(19) United States
(12) Patent Application Publication
(10) Pub. No.: US 2013/0030824 A1
(43) Pub. Date: Jan. 31, 2013

(54) Mobile pharmacy

(71) Applicant: Fayek Todary Michael, Roxboro (CA)

(72) Inventor: Fayek Todary Michael, Roxboro (CA)

(21) Appl. No.: 13/134,219

(22) Filed: Jun. 2, 2011

Related U.S. Application Data
(60) Provisional application No. 61/353,376, filed on Jun. 10, 2010.

(51) Int. Cl. G06Q 50/22

(52) U.S. Cl. 705/2

(57) ABSTRACT

The present document describes a mobile pharmacy comprising: motorized vehicle; Pharmacist, pharmacy Technician, an inventory of healthcare products; a computer system connected to the internet. There is also described the use of a mobile pharmacy to provide pharmacist counseling to various remote areas where it reaches a specific sheltered place in the village to facilitate providing the pharmaceutical and health services to village population.

### CROSS-REFERENCE TO RELATED APPLICATIONS

This application claims the benefit to provisional application #61/353,376

### BACKGROUND

(a) Field

The subject matter disclosed relates to a mobile pharmacy comprising: motorized vehicle; an inventory of healthcare products; a computer system connected to the internet. The subject matter disclosed also relates to the use of a mobile pharmacy to provide pharmacist counseling to various communities.

(b) Related Prior Art

Currently there is a healthcare crisis in Canada and in the USA due to shortage of pharmaceutical services in rural areas.

In Canada, the government of Ontario, (one of the largest provinces providing healthcare services), started exercising financial cuts from private pharmacies and chain pharmacies. The generic pharmaceutical manufacturers were providing financial rebate to pharmacies as an incentive for them to sell generic products as opposed to original pharmaceutical products. The incentive also caused a lot of saving to government healthcare system while it helped small pharmacies sustain their business, especially in rural areas where the population is not big enough to sustain a pharmacy business.

Since about two years ago, the government started cutting 50% of the private rebate from the generic company. Currently, the government has a plan to cut the remaining 50% of the rebate. Nowadays the pharmaceutical sector is fitting against this decision and the small pharmacies in villages are expected to close their doors.

In the United States, many rural pharmacies have already closed due to:

1) Communities in rural areas in many cases do not have a big enough population to support their community pharmacy.

2) Shortage of pharmacists: There are not enough professionals to serve the community people in face-to-face counseling and/or consultation. Most of the times there is no physician in that village, and nearest hospital is far away and not easy to reach. For these reasons the healthcare system in the United States started to adopt the following ideas:

1—RX vending machine: (which has a lot of disadvantages but is a temporarily solution to the problem). The vending machines are designed to be placed in doctors' offices, clinics, emergency rooms and other healthcare facilities. Each holds 100 of some of the most often used medications that can range from pills to drops to creams and so forth. Vending machines, such as those sold by InstyMeds, require that physicians create prescriptions electronically, which are then transmitted to the vending location. The machines include several safeguards to insure patients receive the proper medications their doctors ordered. From the patients' point of view, however, the ordering process is relatively simple. They enter their prescription number and birthday via a user-friendly touch-screen monitor, and then insert either cash or credit cards to cover co-pays, while their insurance companies are billed automatically. The vending machines, which are accessible 24/7, likewise could help alleviate a growing shortage of pharmacists. With no pharmacist present, there is a greater concern for dangerous drug interactions going undetected and a lack of consultation that may negatively impact a patient's health. These machines are stand alone systems not tied into the patients' medical records. Therefore, a drug could easily be dispensed to which the patient has an allergy and a drug disease contraindication etc. The sole check on these important screens which are normally done by a pharmacist would be done by a busy ER physician who knows little about drug interactions and is being pulled in many directions. Medication errors by physicians are far more common than people like to believe. Every day thousands of people go to the emergency department due to these medication errors. However, although the vending machine handles routine prescriptions, it cannot replace pharmacists or perform more important tasks such as counseling patients.

2- Tele-pharmacy: where there is no pharmacist for counseling, some pharmacies are operated by a computer technician in contact with a remote pharmacist through Tele-counseling by using computer screens, web camera and microphones. The patient and pharmacist can see each other face-to-face through computer screens and achieve counseling. Accordingly, the pharmacist is capable of serving the pharmacy customers physically located in the pharmacy equipped with Tele-counseling, and other few remote areas connected via the internet. It is still not known if the remote pharmacist has access or not to the patient's file located at the dispensing pharmacy.

There is a need to serve the rural community with face-to-face counseling with a pharmacist counseling, who would be able to review patient's file and give a solid advice.

### BRIEF DESCRIPTION OF THE DRAWINGS

Further features and advantages of the present disclosure will become apparent from the following detailed description, taken in combination with the appended drawings, in which:

FIG. 1 illustrates a scheme of a mobile pharmacy route in a day-to-day operation of one embodiment of a mobile pharmacy.

It will be noted that throughout the appended drawings, like features are identified by like reference numerals.

### SUMMARY

According to an embodiment, there is provided a mobile pharmacy comprising:

motorized vehicle;

enough inventory of healthcare products and/or testing devices; and

A computer system connected to the internet.

The healthcare products may comprise medical and/or pharmaceutical supplies, such as prescribed pharmaceuticals, over the counter medication, food supplements and vitamins.

The testing devices include, without limitation, blood pressure machine, blood glucose level testing device and blood cholesterol level device, to monitor patient's health and help screen emergency cases.

According to another embodiment, there is provided the use of a mobile pharmacy to provide pharmacist counseling to various communities.

The mobile pharmacy may resupply itself at a station pharmacy.

According to another embodiment, there is provided a method to provide various communities with a pharmacist counseling which comprises a mobile pharmacy to be used by a pharmacist to provide counseling to various communities.

The following terms are defined below.

The term “mobile pharmacy” is intended to mean any vehicle equipped with a computer and a web connection having on board at least one pharmacist and healthcare products of all sorts, such as pharmaceuticals, vitamins, and medical supplies.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature and not as restrictive and the full scope of the subject matter is set forth in the claims.

### DETAILED DESCRIPTION OF THE PREFERRED EMBODIMENTS

In embodiments there are disclosed mobile pharmacies, such as a medium size motorized vehicle having on board most of all common medications and a computer system connected to the internet, either through WI-FI or an antenna plus mobile phone.

The mobile pharmacy depends from a station pharmacy (an operating pharmacy or a storage for healthcare products of all sorts, such as pharmaceuticals, vitamins, and medical supplies) from which it gets its supplies.

The mobile pharmacy is usually staffed with a technician/driver (permanent hire) and pharmacist (relief or permanent hire).

Ideally, in day-to-day operation, either the pharmacist or the driver remains the same at all time to provide a continuous customers counseling.

Each mobile pharmacy can serve several villages per week.

The mobile pharmacy is an extension of its station pharmacy. The mobile pharmacy periodically (each day or every few days) goes back to its station pharmacy to get pharmaceuticals and other medical supplies. Also, the mobile pharmacy through the internet can place its new medication orders or ordering specific medication that is not usually carried in its regular inventory.

Mobile pharmacy can solve the following two main problems:

1) Replacing the lost pharmaceutical services of the closed pharmacies in more than few villages by one mobile pharmacy.

2) Avoid the shortage of professionals (pharmacists), by making one pharmacist serving several villages, providing face-to-face counseling, reviewing patient profiles to avoid contraindication, possible allergic reaction or drug interaction, all of which cannot be achieved by automation.

The big chain pharmacies can promote their own pharmaceutical services and support small community health and well-being using the mobile pharmacy.

The present invention will be more readily understood by referring to the following examples which are given to illustrate the invention rather than to limit its scope.

### EXAMPLE 1

### Day-to-Day Operation of a Mobile Pharmacy

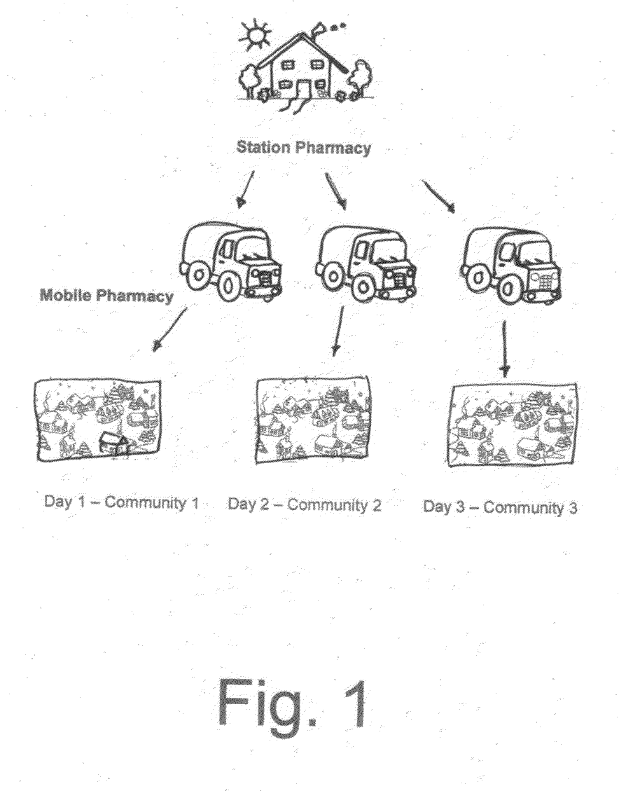

Referring now to the drawings, and more particularly to FIG. 1, a diagram illustrates a mobile pharmacy route in a day-to-day operation of one embodiment of a mobile pharmacy.

As it is illustrated, the mobile pharmacy gets its supplies from its station pharmacy. It provides a link between the station pharmacy and various communities. In this example community 1 to 3 are visited respectively on day 1 to 3. It is possible that two or more communities be visited on a given day.

At least, one pharmacist should attend the mobile pharmacy. It may also include a driver/technician. The pharmacist provides counseling to the community people and fills in the various prescriptions and also provides over the counter products and medication counseling, while Technician gives support by answering the telephone, does patient data entry, prepares medication and acts as a liaison in case pharmacist replaced by another one.

The mobile pharmacy has a computer that is web connected through WIFI or other system. The pharmacist may order the medication from the station pharmacy where the MP belongs to, to be delivered upon return of the mobile pharmacy to its station (usually same day).

While preferred embodiments have been described above and illustrated in the accompanying drawings, it will be evident to those skilled in the art that modifications may be made without departing from this disclosure. Such modifications are considered as possible variants comprised in the scope of the disclosure.

1. A mobile pharmacy comprising:
motorized vehicle;
an inventory of healthcare products and/or testing devices (blood pressure and scale etc.);
Pharmacy Technician/Driver;
Pharmacist; and
A computer system connected to the internet.

2. The mobile pharmacy of claim 1, wherein the healthcare products comprises medical and/or pharmaceutical supplies.

3. The mobile pharmacy of claim 2, wherein the pharmaceutical are selected from the group consisting of prescribed pharmaceuticals, over the counter medication, food supplements, vitamins and testing devices.

4. The mobile pharmacy of claim 2, wherein said computer is connected to the web by a receiving antenna connected to internet waves.

5. The mobile pharmacy of claim 2, which further comprises a printer for printing prescription and/or receipts.

6. The use of a mobile pharmacy of claim 1 to provide pharmacist counseling to different remote areas.

7. The use of claim 6 wherein the mobile pharmacy resupply itself at a station pharmacy.

8. A method to provide various communities with pharmaceutical services and a pharmacist counseling which comprises a mobile pharmacy of claim 1 to be used by a pharmacist to provide counseling to various remote areas.

9. A sheltered station will be available (similar to bus station but more elaborate and comfortable, carrying the name of the mother-pharmacy), equipped with mail box to allow people to leave prescriptions if they can't wait, and telephone box connected only to the mother-pharmacy and the MP.

10. In bigger villages it would be possible to have more than one shelter stations representing different mother-pharmacies. Each indicating its name.
